(19) United States
(12) Patent Application Publication
(10) Pub. No.: US 2016/0163212 A1
(43) Pub. Date: Jun. 9, 2016

(54) Active Learner Multi-media Assessment System

(71) Applicant: Scott Edward Stuckey, Hickory, NC (US)

(72) Inventor: Scott Edward Stuckey, Hickory, NC (US)

(21) Appl. No.: 14/565,419

(22) Filed: Dec. 9, 2014

(51) Int. Cl. G09B 7/02; G09B 5/06

(52) U.S. Cl. CPC G09B 7/02; G09B 5/065

(57) ABSTRACT

A student assessment software system that utilizes digital capture technologies to allow students to combine video recordings of computer activities they as they appear on a computer display with explanations that take the form of a narrated voice track. The invention allows the transmission of these screencast files to occur in a safe, secure, and highly efficient network environment conducive for educational settings where various levels of hierarchical management are assigned to roles to include but not be limited to students, teachers, parents and administrators.

### CROSS-REFERENCE TO RELATED APPLICATIONS

This application claim the benefit of provisional patent Application No. 61/913,920, filed Dec. 10, 2013 by the present inventor.

This application further claims the benefit of provisional patent Application No. 62/034,091, filed Aug. 6, 2014 by the present inventor.

### BACKGROUND

Understanding what learners know, and more importantly, what they do not, has been an educational challenge throughout history. The lecture, the curricular activity, and the science lab experiment, the instructional set can all be brilliantly designed and executed, but critical questions prevail; Did students get it? Did they understand the lesson? Has their level of understanding increased? Is what they learned sustainable over time? The foundation supporting this application recognizes that learning is a life-long process and one that extends far beyond the confines of formal education. Numerous embodiments of the invention are discussed near the end of the Detailed Description section. The embodiment of the invention related to educational assessment is expanded upon here to provide the level of detail necessary to clearly indicate the invention's statutory class, utility, novelty, and unobviousness.

In recent years, educators have been under increased requirements for accountability involving student testing, which exists as important learning components, but often stands in direct competition with classroom instructional time and learning resources. Efforts to reduce the time and expense associated with testing has resulted in prior art that largely assesses memorization and recall at the expense of higher order thinking, problem solving, and creativity. When attempts are made to assess more challenging learning attributes, they most often occur as writing prompts even though it is widely accepted that most students struggle to adequately express their thoughts and level of understanding through written expression. Additionally, while the student use of computer technology and the availability of online curriculum are increasing exponentially, the adoption and implementation of available assistive technologies, many of which already reside on most computer devices, has not been adequately developed. The present invention supports Universal Design for Learning (UDL) principles, guidelines, and practices to help foster learner engagement by presenting information in multiple formats and by providing users with various options for action and expression.

### BRIEF SUMMARY

The educational embodiment of the invention is a software program that establishes online channels of communication between student(s) and their classroom instructor(s). The primary objective for this embodiment is to combine computer-based learning engagements with a novel approach towards assessing students in an effort to maximize the efficiency for instructional time, resource allocation, and conceptual development. Multimedia production and presentation processes promote student learning outcomes through the interplay between system features, learner characteristics, and cognitive processes. Screencasting, a multimedia digital recording of computer display activity typically accompanied by a narrative audio track which details the computer event being captured, has been used for training computer users for over a decade. Many K-12 and higher education teachers use screencasting as an online or stand-alone tool with traditional approaches to enhance instruction, provide learning support, and engage students. Current art uses instructor-based strategies as an effective means to describe step-by-step processes, explain concepts, or present narration, creating a digital recording of any instructional activity performed on a computer screen. Certain screencast programs also take advantage or a computer's built-in camera or a mounted webcam to capture an additional video of the actual operator(s) as they explain the events taking place on the computer. This video often appears in the finished screencast as a picture-in-a-picture format commonly seen with television media. A growing number of educators, including those involved in the flipped classroom teaching model, are presenting students with instructional screencast tutorials from hosting websites such as the Khan Academy, TeacherTube, and YouTube. Students who watch these instructional videos typically view specific activities performed on a computer or procedural events captured by a document camera while simultaneously listening to a narrative explanation provided by the instructor. The flipped classroom model often asks students to watch these tutorials at home in an effort to free up more classroom time for hands-on activities and one-on-one assistance from the teacher. The effectiveness of these screencast tutorials has been demonstrated through numerous studies and evidenced by the growing number of participatory; however, all of the screencast videos that result from the current art are created by the instructors, with learners serving as members of the viewing audience.

It has been demonstrated through research that having students create screencasts provides strong cognitive support for active engagement and produces assessment products that are far superior to the more traditional form of writing. This embodiment advances screencasting from a teacher-centered process to a learner-centered activity. Students assume roles as active thinkers and problem-solvers as compared to content recipients when compared to prior art models of screencasting. Student screencast productions require learners to think and act upon the knowledge they acquire in a different manner than when they listen to or absorb lecture information. Screencast assessments provide educators with a learner-centric response that reveals far more about the student's thought processes and levels of understanding when compared to traditional forms of assessment such as writing or other evaluative instruments that include multiple choice and/or true/false questions. Depending upon the preferences of the instructor and/or learning strengths of the individual user, additional features included with this embodiment provide access to a wide variety of input components that can be used either in combination with the screencast assessment tool or as standalone devices.

There currently are no commercially available or open-source screencast products designed to encourage learner-centered screencasting as a means of student assessment. In addition, no screencasting program provides educators with the necessary features to incorporate the various access levels required to monitor student activity, generate and distribute formative and summative feedback, and maintain student accounts that reflect real-time course scheduling. The current art for screencast platforms also lack protocols that satisfy federal and state mandates regarding security, privacy, confidentiality, and protection for students. Enabling learners to operate an age-appropriate screencast device to create media files that are easy to manage, review, and distribute is, in and of itself, a novel use of screencasts. The addition of a teacher assessment component integrated with a screencast creates an innovative and enabling technology that has the potential to revolutionize the use of educational assessments.

While there are many commercially available and open-source screencast, image capture, and voice recording applications, none offer features that cater to the needs of students and teachers in an educational setting. Commercially available premium screencast applications, including Camtasia, ScreenFlow, and Adobe Captivate, provide a vast array of post-production features that tend to distract students from overall learning objectives. Open-source and free programs, such as CamStudio, Jing, and VLC offer more flexibility for future development and have fewer features that might interfere with learning, but lack inherent classroom management capabilities and are simply not suitable for system integration strategies, data analysis, and account management responsibilities. What makes this invention novel is not the actual use of screencasting and other media recording applications, but the implementation of such procedures in a networked educational software suite designed to both assist learners with computer-based inquiry activities while simultaneously assessing their learning progress.

### BRIEF DESCRIPTION OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 shows a flowchart for how the educational embodiment of the invention is connected to the instructor, students, and network infrastructure.

FIG. 2 shows a computer display that is running the embodiment and the various selections that are made available to users through a program menu.

FIG. 3 shows a graphical user interface of the educational embodiment during a typical curricular activity.

### DETAILED DESCRIPTION

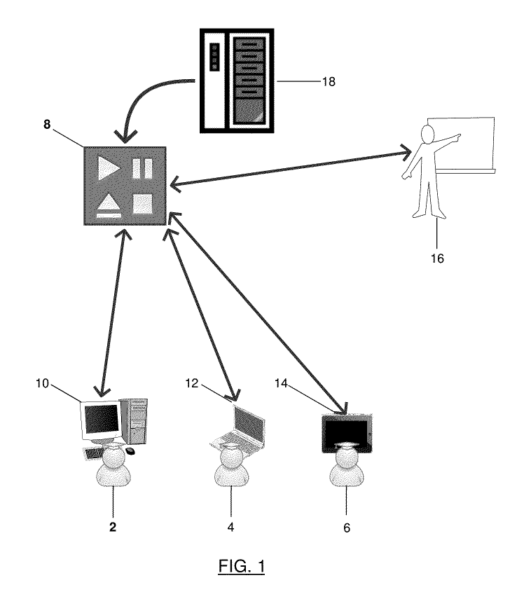

Referring now to the educational embodiment of the invention in more detail, FIG. 1 shows various students 2, 4, 6, interacting with the invention 8 using a variety of computer devices which include, but are not limited to, a desktop computer 10, laptop computer 12, and tablet computers capable running at least two programs simultaneously 14. Also displayed in FIG. 1 is a teacher 16 using the embodiment 8 to monitor activity conducted by students, analyzing assessment data recorded by the embodiment 8, and providing feedback to individual students 2,4,6, and/or the whole group of students.

In more detail, still referring to the educational embodiment 8 of FIG. 1, the software is designed to reside on a server through a local area network (LAN) such as a school building, a wide area network (WAN) such as a school district or state department, or the in a cloud based management system consisting of delivery and host machines maintained in off-campus location(s). User access to this embodiment is administered and maintained through individually licensed accounts that vary with regard to administrative permissions, storage capacity, and levels of interaction with other users.

The educational embodiment can be started by selecting from a program listing in the Applications folder on a Mac OS device, the Start Menu on a PC Windows operating system computer, or similar program listing found on various portable devices. At time of installation, a choice will also be available to send a start-up icon to the computer's desktop, systems tray, or browser toolbar. Once the decision has been made to start this embodiment using any of these described means, the user will be prompted to sign into their account by entering their specific username and password. Depending upon administrative preferences, access to this embodiment of the invention can be restricted to specific computer devices within a school or broad enough to include all computer devices capable of operating within a LAN and/or WAN. Network settings for the embodiment could also be set so that access could be gained via a secure, password protected, executable file and/or web application through most any computer device having access to the internet. Individual user accounts could also be monitored, restricted, and/or created by assigning specific rights to various access levels by the site administrator(s) designated by system personnel acquiring the invention.

This embodiment of the invention will support the School Interoperability Framework (SIF) standards to allow management through a Zone Integration Server (ZIS) and reside as a zone object for academic institutions already deploying this industry initiative. Such integration will support a streamlined learner management program to ensure the secure and efficient transfer or real-time data, promote the use of single sign-on solutions, reduce administrative costs and time allotments required for account maintenance, and support interoperability with other data management systems residing at the district, state, and/or federal levels. The embodiment will also support 2.0 SIF Web Services to allow communication in and out of the zone, thus enabling communication with many types of mobile devices and access points outside the LAN and/or WAN.

It is important to note that initiating a session with this embodiment does not supersede or force closure for any computer programming running prior to the start of such a session. The embodiment is designed to assess student learning by capturing a video of the computer activity as it occurs on the display device while providing the user with an option of recording his/her voice as the visual images from the computer are being captured—a process commonly referred to as screencasting. Students will also have access to an onboard tool which includes an audio recording device, an image capture tool, and a fully functional word processer. The multi-media learning products that are created through the use of this embodiment will be available for immediate review by the student user in an effort to promote self-assessment during the activity and provide opportunities for modification and or refinement as deemed necessary. Combining the word processor with the playback feature enables the student narrative to assist with written compositions pertaining to the computer activity. Additional assistive learning devices will be included with this embodiment of the invention (detailed later in this section).

Teachers are able to monitor student activity, review screencast assessments as soon as they are saved by the student, and provide formative and summative feedback to individual students or to an entire class. Teachers will have the means to use the embodiment to provide feedback to students in the form of screencasts, voice notes and text entries. Educators can also use the program to create tutorials videos intended for classroom, grade level, school-wide, and/or district-wide consumption. These tutorials and the screencasts that are created by students can be viewed by most devices capable of accessing the internet. Additional features, described in greater detail below, will assist teachers with scoring assessments and managing the student data generated by the invention.

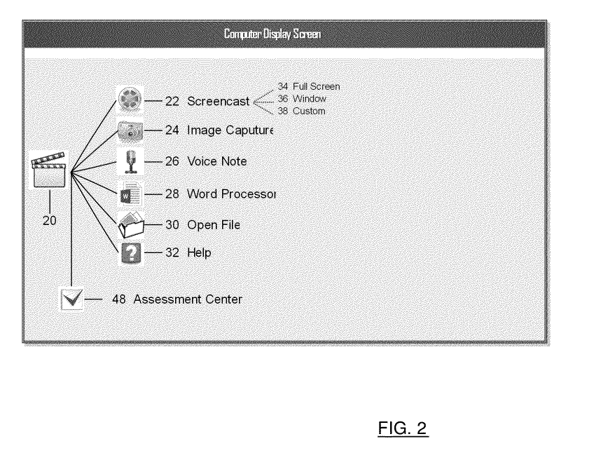

The embodiment can be set to run automatically upon system startup, or it can be accessed through desktop icons, system tray icons, or through a program menu. When the embodiment of this invention is started, a selection icon 20 appears at a specific location on the computer display screen (FIG. 2). The selection icon 20 can be moved to different locations on the perimeter of the display by dragging and dropping with a left-mouse button on a desktop or laptop computer system 2, 4, or moved by using the touch screen on certain tablet computers 6. This feature permits movement to a location on the display that does not conflict with the user's activity, thus making the embodiment available on-demand throughout the entire computing session regardless of what other program(s) may be running. If a mouse cursor or similar selection device hovers over the selection icon for a short period of time, a pop-up window appears and provides the user with the six selection icons referred to in the schematic diagram displayed in FIG. 2.

The first icon from top-to-bottom takes the form of a film reel 22 and has a rollover tag labeled “Screencast” and is intended for students wanting to create a screencast assessment of their computer activity. The second icon from the left depicts a camera 24 and is intended for users that want to capture a still image from their computer activity. The third selection icon is represented by a microphone graphic 26 and reads “Voice Note” when hovered over. The voice note feature is designed for students that want to record their voice during a computer session and have those recordings available later for review and/or submission to their teacher. The fourth icon selection depicts a piece of notebook paper 28 and represents the word processing tool which is used to create text entries by typing on a computer keyboard, keypad, or by using speech-to-text software inherent to the computer operating system supporting the invention. Selection five from the top 30 depicts a file folder reads “Open File” when hovered over and provides users of the embodiment access to previously recorded screencasts, images, voice notes, and text entries captured by the embodiment of this invention. The last icon appearing in this pop-up window takes the form of a question mark 32 and is labeled “Help”. It provides users with assistive tutorials, indexed information on how to use the program, an “About” section which lists the manufacture and series edition for the embodiment, and a means to close and exit the program.

Referring to FIG. 2 in more detail, selecting the screencast icon 22 provides three additional choices based on the area of the computer display to be recorded: Full Screen 34, Window 36, or Custom 38. If the Full Screen option is selected “Record” icon appears in the center of the computer display. The “Window” selection prompts the user to first select the active window to be recorded and then the “Record” icon appears in the center of that specific window. The “Custom” icon selection changes the mouse or touchpad curser to a cross-hair feature that allows the user to place it in the top-left corner of the area to be recorded, hold the left mouse button while dragging to the opposite corner. As the left-mouse button is released, the Record icon appears in the center of the custom area just defined. When the “Record” button is depressed within any of these three regions, a count-down window is displayed with audio and video recording beginning as the countdown reaches zero and disappears from view. During the recording session, all components of the computer program being recorded remain fully functional and can be manipulated by students at any point during the session.

Once the screencast assessment recording session has started a transparent control panel offers numerous selections. The volume level status bar and microphone icon assists students by ensuring that the audio input is working properly and that the student narration levels being captured during a screencast assessment recording session are at optimal levels. If no audio device is detected, the microphone icon on the control panel will display a universal no symbol (red circle with backslash) covering it. The universal no symbol will also appear of the microphone icon if the student selects the “Mute” button on the control panel. Selecting Mute will allow the screencast assessment to record the visual aspects of the computer display activity, but will not include any audio input. Assuming that the Mute button was not depressed, as a student begins to speak, an audio input level is presented as a horizontal bar that moves from left to right as an indicator of low to high volume. Audio input levels that are deemed too low (10-30% on the bar) will appear as a green bar that flashes. If recording levels are too low students can increase the microphone input value on their headset device or through the audio mixer residing on the computer, adjust to position of the microphone on their headset, or decide to speak louder. Volumes in the optimal range for playback (31-60%) will appear as a green bar with no flashing. If volumes are too high for clear playback, the horizontal extends beyond the 61% mark and its color changes from green to yellow. If volume input levels exceed 80%, the status bar changes to red and begins to flash.

Screencast assessments can be paused temporarily stop the recording session and allow the computer activity to continue. The “Pause” icon is immediately replaced with one that prompts users to “Resume” recording the assessment. The “Stop” icon stops the recording session and prompts users with the following four choices: “Preview”, “Submit”, and “Discard”. “Preview” allows the user to watch the screencast recording through a playback feature inherent to this embodiment of the invention. The preview feature appears in separate pop-up window and contains its own Play/Pause icon along with a play head that could be scrubbed to a specific point on the screencast timeline. Both the audio and video tracks are aligned with the play head which enables a student to view and listen to the assessments they just recorded at any particular point in the capture. The word processing icon also appears in the preview feature and the resulting combination of these two features is illustrated and discussed later in this section. Minimizing or closing the preview window (upper-right controls in Windows OS, or upper-left controls in Mac OS) returns students to the screencast assessment feature displaying the same options when the screencast was stopped (Preview, Submit, Discard).

When a user is ready to submit an assessment, the file storage destination and naming protocols are pre-determined and managed by teachers and/or other site-based administrators having access to classroom, school, and/or district setup options. The default setting for the submit feature provides the most flexibility for student users as it permits assessment files to be stored at any location accessible by the student user and allows them to name the files on their own. Understanding the demands placed on many schools and districts regarding adequate electronic storage space, sufficient bandwidth, and network security, various administrative options are available with the embodiment that help offset many of the detrimental issues associated with strategic network policies. One administrative option permits mapping screencast assessment files to student, teacher, or administrative folders within the LAN, WAN, or Cloud-based environment. This option dramatically reduces the amount of required navigation and saves valuable time when teachers need to review and provide feedback for student assessments. Individual file destinations can be modified to allow or forbid access to files once they have been submitted and/or allow viewing by others. Teachers and/or site administrators may choose to have student files named automatically based on a combination of the individual student naming protocol, date, and time of submission or they may opt to permit custom naming from the user of the invention. Personnel responsible for network management that acquire this embodiment of the invention will be able to place limits on the maximum file size and the total number of files that can be saved to a particular computer hard drive and/or the system's networked storage repository. Finally, “Discard” closes the screencast frame and control center, but keeps all other computer software operating as it was prior to, or as a result of the recording session.

Referring again to the schematic representation in FIG. 2, the second icon 24 from the top depicts a camera and contains a rollover tag of “Image Capture”. This selection allows users of the embodiment to capture still images of content displayed on the computer screen. As with screencast assessments, users of this embodiment that select this Image Capture feature will be provided with choices to capture the entire computer display by choosing the “Full Screen” icon, a particular window on the graphic user interface (GUI) by selecting the “Window” icon, or a custom area can be defined and captured with by selecting the “Custom” icon. The means of file storage, naming, and retrieval for images captured by the invention are similar to details for screencast assessments described earlier.

The microphone icon 26 representing the third icon illustrated in FIG. 2 and allows students to use the voice note feature to create audio recordings during any time they are signed into the invention. When this icon is selected a simple control panel appears in a floating, semi-transparent window and provides students with options that include record, pause/resume, and stop. A recording volume status bar is designed to give students information about the optimal audio levels for their voice recording and functions similar to the screencast assessment volume status bar described in paragraph 10. As with the screencast preview feature described earlier, students that decide to listen to previously recorded voice notes can choose to have the word processing feature present when reviewing their voice notes. The means for saving, storing, and retrieving voice note files is similar to processes detailed for screencast assessments.

The fourth icon in FIG. 2 illustrated by a piece of notebook paper and labeled “Word Processor” provides students with a simplified word processing tool that can be used at any point during a session. The word processing features made available through the embodiment are relatively simple, very easy to use, and emphasize more about the writing process and less about presentation and compatibility when compared to many other commercial and open-source word processing programs. Assistive features available to students that use the word processing feature will include, but not be limited to emphasis tools (e.g. bold, italics, underline), copy/paste, highlighting, and a spellcheck feature. In addition to the “Submit” feature that functions similar to the one described in paragraph previously, students using the Word Processor provided through the embodiment will have a “Save As” feature that allows them to name individual text files and place them in locations where they have access to storage. All text generated through the word processing tool can be copied and pasted into other word processing and/or office productivity software suites where they can be further enhanced graphically, analyzed with greater precision, receive insertions, be printed, etc.

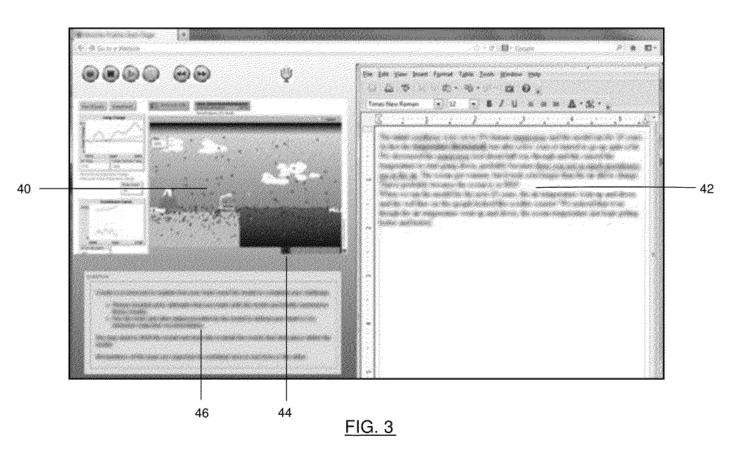

As illustrated in FIG. 3, selecting the word processing icon from within the preview feature positions the preview components 40 on the left-hand portion of the active window and places the word processing tool 42 to the right. Combining the screencast preview feature 40 with the word processing tool 42 affords students with the opportunity to move a scrubhead 44 and quickly navigate to a specific location for a previously captured computer activity, watch events as they were displayed on the computer, listen to their reasoning and comments regarding those events, review aspects of the activity as many times as necessary, and utilize all of those learning attributes to formulate written responses that reflect levels of student aptitude and understanding for the concepts presented through the computer activity. Written responses can be refined, saved, submitted without having to close or exit the screencast preview area. FIG. 3 also shows a set of directions/questions that appear in the display. This area is designated for teacher-led activities where the digital content can be embedded into the preview area 40, saved as an activity and then made available to users as an assignment. Using this feature limits the students' ability to browse the internet and possibly stray off-task.

Certain embodiments of the present invention offer additional assistive learning services designed to help with various forms of communication and knowledge expression. Coupling the invention with speech-to-text software programs that are commonly bundled on most operating systems (Apple's Dictation on Mac operating systems and Windows Speech Recognition on Microsoft Windows operating systems) and certain internet browsers (Dictation app on Google Chrome), will allow students that are screencasting to talk through events as they are being captured on a computer and then view and edit their spoken words moments later within the word processing tool. This same feature will also convert student audio captures into text conversations.

The fifth icon from the left in FIG. 2 depicts a file folder with a rollover tag that reads “Open”. This option allows users of this embodiment of the invention to browse to and open any previously saved screencast assessments, captured images, and voice notes. Students will also be able to switch to a “Details” view within this window to show the files listed by name, time of capture, file size, and each will have the appropriate media type icon to the left of each file name. Files observed in both the Thumbnail and Details view will be sortable by either alphabetical order based on file name, time of capture, or file size. Double-clicking over a thumbnail or file name with a mouse (or double tapping on a touch screen) will open the appropriate file in the main viewing area and provide the same playback features for each media type as described previously in this section.

Another embodiment of the current invention would provide text-to-speech options that would offer additional assistance to those students who struggle with language issues or have difficulty reading at grade level. This feature, commonly referred to as a text reader, will allow students to listen to text that is selected/highlighted from content running on the computer at that particular time. This same feature will also allow students to listen to the text they created and/or copied and pasted within the word processing tool.

An additional embodiment of the current invention would utilize the computers onboard video camera or attached webcam to simultaneously capture a second video of the computer operator. This video is in addition to the primary recording of the computer activity as displayed through the computer's monitor. Viewing screencasts that were recorded with this feature would display a smaller window portraying the computer operator embedded within the larger display depicting the computer activity. This feature would cater well to students who use sign language as a primary means of communication. The webcam feature could also be used to capture facial expressions of learners which could be used to provide insight as to the emotional state of the computer operator at the time of assessment. The webcam feature could also be used to provide visual input for items that may not be easily transferred into the computer activity. For example, educational researchers could also use this feature to study certain aspects regarding the affective domain associated with the learner; were they paying attention, did they seem highly motivated, did they display signs of anxiety, etc. Students could also use this feature to visually document types of content that could include a groups' lab apparatus setup, a hand drawn poster, or any image contained within a book, periodical, or other non-electronic format.

Developmentally delayed students, those with autism spectrum disorder, or learners with a limited range of verbal abilities may very well benefit from the object-oriented option included with another embodiment of the invention. In this mode, predefined digital objects that might take the form of pictures, clipart, words, phrases, symbols, etc. would be available to students in an object library appearing near the perimeter of the screencast window. Once a student had started a screencast in the object-oriented mode, clicking on an object would trigger a subtle, but openly visual indicator that the object had been selected. Clicking on that same object a second time would deselect or undo the selection and place it back to its default visual state. Any number of objects could be selected at various points during the activity, but programing restraints would ensure that no two objects could be selected at the same time. Once the screencast recording was stopped, the playback feature would include an object tray that would appear directly beneath the active viewing window. As the screencast is played back by either the student or their teacher, each item that was selected and deselected during the recording phase would appear in the object tray for the specified amount of time it was actively selected. Thus, the object tray would serve as a timeline to present student selections in chronological order as the playhead progresses from left to right.

Students who have selected object-oriented path would be able to perform object manipulations while recording or during the playback mode. For example, if a student felt that they did not allot enough time for a particular object selection, they could grab a handle on either side image in the object tray and drag it to span the desired length of time. They could also delete items from the tray, move them to different locations, or drag new objects from the library and place them directly into the object tray. Potential applications for a software tool of this type might involve simply labeling the various seasons as a simulation of Earth's orbit around the sun appears, selecting active or passive voice while listening to dialogue from a popular movie clip, or applying the proper labels for the types of angles found among two congruent triangles presented through an interactive simulation.

Teachers that access the invention using their individual credentials will have experience the same features and options as that students do, but their GUI will be markedly different from the student experience so as to clearly distinguish it from a student profile. Teachers will have access to an additional sixth icon 48 illustrated in FIG. 3 as a checkmark and containing a rollover tag of “Assessment Center”. This feature allows teachers to create new assessments, open an existing assessment, or manage multiple assessments. When creating new assessments, teachers are able to title the particular assessment, assign start and finish dates for student access, supply point values and/or assessment types, and include existing classes and/or individual students for participation. Instructional information that can be included with each new assessment can come in the form or text, voice note, and/or screencasts. Teachers will be able to insert hyper-links and images into the body of the instructional portion of the assessment and attach files as deemed necessary. These features will ensure that students have a good understanding for what they are being tasked with as much of the digital content that they work with is not labeled to reflect the learning tools and specific tasks associated with the invention. When creating new assessments or editing existing ones, teachers can select an alert option which notifies students and provides a link to the new assessment immediately after logging into their individual accounts. For systems that support student email programs and instant messaging services, alert messages can also be sent in the form of an email, chat notification or text message to all members assigned to the new assessment. Opening existing assessments provides teachers with the same interface and functionality described above. Instructors will be able to selectively move assessments to different file destinations add or remove students from multiple assessments, and archive assessments that contain student data and teacher feedback.

This embodiment of the invention allows teachers to monitor student activity, provide feedback, and grade student assessments through a number of methods. Student data pertaining to individual assessments can be accessed by teachers based on course membership, class sections, or on an individual basis. When accessing multiple accounts through the course or class section options, individual students that have submitted the assessment, will appear with a green dot associated next to their name, those that have opened the assessment but have not submitted it will display a yellow dot, and a red dot will indicate that the assessment has not been accessed by the student. By default, students will be listed in alphabetical order in these two views, but provisions are available to sort the student accounts by completion status.

Double-clicking a student name displayed in one of these views, or selecting a particular student after an assessment choice has been made, opens the student work in a pop-up window very similar to the student preview feature described previously. Additional features include a “Feedback” option that allows for affirming or corrective comments to be made in the form of screencasts, voice notes and text entries. Feedback can also be provided in the form of an attachment which allows content to take the form of a screencast, image, video segment, pdf files, etc. Specific comments can be saved in a repository and later retrieved when applicable to other students and/or classes. When digital activities are being monitored by an intelligent tutoring system designed to track student progress, similar but not limited to a Bayesian knowledge tracing (BKT) model, DOCENT, SimQuest, and Cognitive Tutor, the affirming and corrective feedback files created by teachers could be systematically retrieved by the progress tracking system and delivered automatically to the computer user or users engaged with the digital activity. Scoring assessments and applying saved comments can be done on an individual basis or applied uniformly to a class or course of students that have submitted the particular assessment. Teachers will also have an option to allow students to revisit the assessment, make modifications, and resubmit for a subsequent review.

As scores are entered by the teacher for individual students or on a whole class basis, they will also appear in an electronic gradebook included as a feature with certain embodiments of the invention. The gradebook will allow teachers to track student progress over an extended period of time. The gradebook will take the form of a spreadsheet with student names listed vertically to the left, assessment titles displayed across the top, and individual grades filling in the matrix created by the two variables. The status indicators that were discussed in paragraph will also be represented in the gradebook as faint background colors for each individual cell in the gradebook matrix. The electronic gradebook provided by this embodiment is not intended to replace those used by host districts or states, but it will follow SIF compliance standards to support exporting student data from the embodiment into commercial record keeping programs that follow the same compliancy standards. For educational systems that are using course management programs such as WebCT, Blackboard, or Moodle, this embodiment of the invention will include accommodations for storing and retrieving screencast assessment files within these platforms. The embodiment will also support the Lightweight Directory Access Protocol (LDAP) standards to better accommodate existing directory services established by other organizations.

While the educational realm serves as the immediate audience for this invention, other embodiments of the invention cater to a wide sector of the general population. Relatively minor modifications made to the source code, user interface, and network capacity would result in a software platform with capabilities to both assist with training of personnel in the Armed Forces, provide valuable assessments as to their proficiency with highly complex computer programing while simultaneously providing their trainers with a feedback mechanism that utilizes the same platform that the trainees or those involved with re-certification are working with. The invention is designed to record data in a visual format regardless of how complex the technology is that is driving the imagery that appears on the display screen. The use of the invention would not be limited to computer activities involving high-tech simulations and complex models as the inherent features that make the invention so attractive are readily applicable to those learning about the correct use of a payroll system, operation of HVAC equipment, proper procedures for engaging with civilians while abroad, or even something as simple as how to file the proper paperwork for an upcoming leave. Providing service personnel and their trainers with assessment options that include screencasts, voice notes, text entry, object-oriented selections will not only cater more to the specific strengths of the individual and/or task and help reduce certain barriers often associated with reading and writing abilities that can skew assessments designed to measure hands-on performance. Implementation of an embodiment of the invention within military will also dramatically reduce the amount of time required to properly assess performance, provide adequate feedback, and make the necessary adjustments to maximize the effects of the tasks being assessed.

An embodiment could also be adapted to satisfy many of the professional development (PD) and training needs within the corporate environment. A growing number of companies already provide screencast productions (often referred to as online tutorials) to deliver training for their employees and/or product consumers. The screencast format is especially popular for tasks that are highly procedural in nature. With current art, the employee assumes a passive role by watching and listening to the prerecorded screencasts, and while they may be prompted to answer questions related to understanding at intermittent intervals, they do not actually experience the programing they are being trained on until after their experience. The approach for training inherent to the current invention places the employee in control of the program they are attempting to learn and tasks them to demonstrate proficiency by actually working with the program as opposed to reflecting upon their experience after their activity. While there are some simulated programs that will allow the operator to continue with subsequent steps only when the correct sequence is established, our invention recognizes the value of allowing for mistakes and rewards the user by providing an easy means to learn from their actions in a learning context that documents their reasoning capability as they initiate corrective actions.

Product consumers would have an additional benefit when using the invention as a means of seeking help from the support staff that created the online or computer-based product they are experiencing difficulties with. The invention could be adapted for use by the consumer that is confronted with a situation they can't overcome on their own. In this context, instead of having to write-up and submit a descriptive explanation, engage in an online chat session, navigate through a lengthy FAQ listing, or call a support number during regular business hours, the consumer could simply open the program they are having difficulties with on their computer device, click on the “Record” option that is made available through a “Help” section provided by the manufacture's online technical support staff, and then create a screencast that not only provides a visual representation of the program and corresponding actions taken by the consumer, but provides a verbal account of the exact tasks or procedures they are struggling with.

Another embodiment of the invention could be introduced to the online gaming community as a means of documenting individual accomplishments, creating instructional tutorials to be shared through a social network of gamers with similar interests, and developing a greater sense of personalization for online avatars and/or other forms of digital personifications. For players in online games that support a social presence, instead of simply showing an overall score and current ranking, the software developer that uses this embodiment could also present a video recording of the users display screen combined with their comments made during the activity that afforded them with such a ranking. Being able to provide a user's avatar with oral inflections recorded by the actual player as a means of introduction prior to a gaming session, as a way of submitting comments or questions during a session, or as a means of announcing or accepting an individual final status with the game would provide players with a unique experience and increase the market potential for the software developer integrates this embodiment into their gaming platform.

Another embodiment of the current invention would combine voice capturing technologies with existing hardware interfaces associated with scientific probeware devices designed to collect data during investigative activities. A growing number of probeware interfaces, which include but are not limited to Pasco's SPARK Science Learning System and Xplorer GLX Graphing Datalogger, Vernier's LabQuest 2, and NeuLog Logger Sensors, come bundled with display screens that permit much of the experimentation and data analysis to take place independent of a traditional computer system. While these devices are designed to be standalone solutions that permit explorations to be performed in a traditional lab setting or in the field, they generally lack the capacity to collect information from users that may need to state a hypothesis before beginning data collection, answer specific open-ended questions associated with the activity, describe their experimental setup in detail, provide a descriptive interpretation of the results, and/or submit conclusions pertaining to the experimental activity. These types of responses associated with advanced probeware interfaces are traditionally written out in the form of a lab report, or combined with data analysis programing that resides on a separate computing device (ex. desktop computer, laptop, tablet and other mobile devices) from the probeware interface itself. Allowing the users voice to be captured by the probeware interface before, during, or after a data collecting event would significantly reduce or completely eliminate the requirement for having a secondary device to collect user responses. This embodiment would allow the interface device to perform as a true field device from start to finish, result in improved performance on behalf of the user, and reduce the amount of time currently required to transfer information from experimentation activities where a centralized resource officer (ex. teacher, professor, lab manager, research director) is collected data from multiple sources (ex. students, lab technicians, field researchers).

Another embodiment of the current research would combine voice and screen capture technologies with graphing calculator devices and associated computer applications. Enabling current graphing calculators which include but are not limited to Texas Instrument's TI and Nspire series, Casio's FX series, and Hewlett Packard's Prime and g line of graphing calculators, with the capacity to record the visual events that take place on the devices display screen combined with an audio track recorded simultaneously or during post production would significantly enhance the educational value for such devices. Similar capturing technologies could also be associated with graphing calculator computer applications that reside on host devices which include but are not limited to traditional computers, laptops, tablets, e-readers, smart phones, and other mobile devices that contain an active display screen. Users would then be able to present the sequential order of events used with any given calculation and provide verbal reasoning as to why and/or how they decided upon applying their logic in that way, how they supported their findings or activities, and/or relay messages to the instructor for clarification purposes or place a request for additional instruction. Playback of these recordings would allow learners to self-assess their reasoning and repeat the procedures if they deemed necessary. The learning products resulting from this embodiment would provide instructors with a far more information about the student's decision making process while engaged with activities that involve graphing calculations, data analysis, and other activities of a mathematical nature. It would also provide instructors with documentation as to their students' progression with activities associated with graphing calculations.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

1. A method of operating a computer system upon more than one processing program concurrently for improving a plurality of information processing units interconnected by a transmission system, comprising:
a. storing a series of video frames captured at a plurality of frame rates of the one or more processing programs,
b. receiving from a user, via one or more input devices, input relating to a series of characters in a memory,
c. displaying, via a display that is in operative communication with the memory, the series of stored characters including said video frames,
d. providing a pointer means for use by the user to point to any:
1. location between the series of characters, and/or
2. activity revealed through via the display resulting from the one or more processing programs; and
e. providing a transmitter which provides hierarchical levels of managerial control to another user and allows or denies access to the computer system and the memory,
wherein the computer system enables capture of the series of video frames comprising the one or more processing programs and permits an assignment of a plurality of roles to one or more users pertaining to system access, memory storage, video retrieval, and file sharing.

2. A computer system that improves a plurality of information processing units, the system comprising:
a memory configured to store video captured at a plurality of video of frames rates of one or more processing programs;
one or more input devices configured to receiving input relating to a series of characters and storing the series of characters in the memory;
a display device that is in operative communication with the memory and that is configured to display the series of stored characters and the plurality of video frames;
a pointer device configured for use by the user to point to any:
1. location between the series of characters, and/or
2. activity revealed through via the display resulting from the one or more processing programs; and
e. a transmitter which provides hierarchical levels of managerial control to the user and allows or denies access to the memory,
wherein the computer system enables capture of the series of video frames comprising the one or more processing programs and permits an assignment of a plurality of roles to one or more users pertaining to system access, memory storage, video retrieval, and file sharing.

3. A non-transitory computer-readable medium comprising one or more instructions that, when executed, causes a computer to perform the method of claim 1.
